(19) United States
(12) Patent Application Publication
(10) Pub. No.: US 2003/0061747 A1
(43) Pub. Date: Apr. 3, 2003

(54) Magic can

(75) Inventor: Christian Prost, Tsim Sha Tsui (HK)

Correspondence Address: BACON & THOMAS, PLLC, 625 SLATERS LANE, FOURTH FLOOR, ALEXANDRIA, VA, 22314

(73) Assignee: Intermed Asie Co. Ltd., Tsim Sha Tsui (HK)

(21) Appl. No.: 10/083,595

(22) Filed: Feb. 27, 2002

(30) Foreign Application Priority Data
Sep. 30, 2001 (CN) 01 2 65698.4

(51) Int. Cl. G09F 19/12; B44F 1/00

(52) U.S. Cl. 40/427

(57) ABSTRACT

This invention is a kind of magic can, which is consisted by 8 fan-shaped columns and forms 16 fan-shaped surfaces pasted with 8 fan-shaped patterned stickers, 16 square surfaces pasted with 8 double-block stickers, 8 surfaces of circumference pasted with four fan-shaped column sticker and 2 hemi-cycle stickers. A sticker may be pasted on 2 surfaces so these 8 fan-shaped columns can be linked together and turned to present various kinds of styles like magic. It offers the entertainment of brainstorming and can also improve the visual effect to reach the promotion purpose. In addition to the entertainment, it can also be used as a card clip or other stationery.

### BACKGROUND OF THE INVENTION

1. Field of the Invention

An invention with patterned stickers for turning game can be used for many purposes, such as brainstorming game, advertisement, and stationery.

2. Description of the Related Art

The well-known square can only be played by changing each square. It lacks change of look and can only be turned in a certain way. The complicated structure does not bring the player much fun, and the difficulty to turn it back to the original look easily frustrates the players and reduces the entertainment effect.

Besides, the square can only be used for entertainment. It does not present a pleasant visual effect and has no added value. In this modern society full with creativity and variety, it can no longer meet the consumers' satisfaction. Most of the time, it is put aside after being played for several times and thus cannot be kept for long. Therefore, to create a multifunctional magic square, which offers the entertainment and present the pleasant visual effect has become the main point of this invention.

### SUMMARY OF THE INVENTION

The main purpose of this invention is to offer the entertainment and reach the promotion effect through the brainstorming game and advertisement patterns. It can also be used as stationery, which may heighten its added value.

The embodiment has 8 fan-shaped columns. The stickers are cut and pasted in a special way, and this makes the invention easier to be operated. By turning these 8 fan-shaped columns, this invention can present magical change of patterns. This is another purpose of this invention.

### BRIEF DESCRIPTION OF THE DRAWINGS

FIG. 1. Three-dimension drawing of this invention

FIG. 2. Structure analysis drawing

FIG. 3. Drawing of operation instruction (1)

FIG. 4. Drawing of operation instruction (2)

FIG. 5. Drawing of operation instruction (3)

FIG. 6. Example

### DETAILED DESCRIPTION OF THE PREFERRED EMBODIMENT

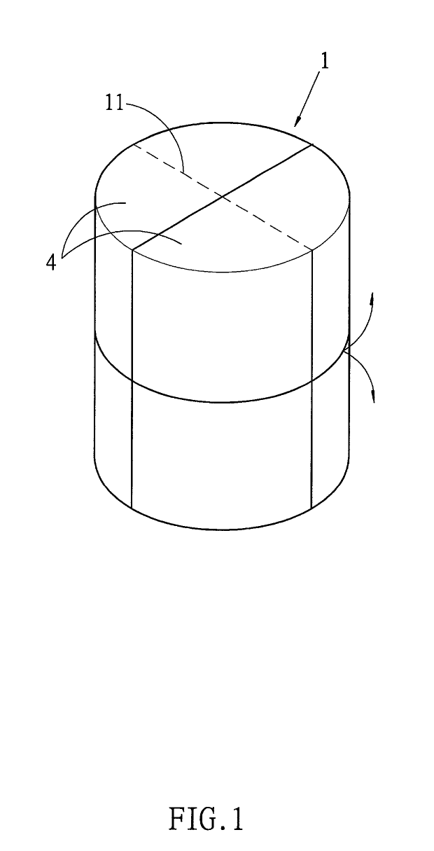

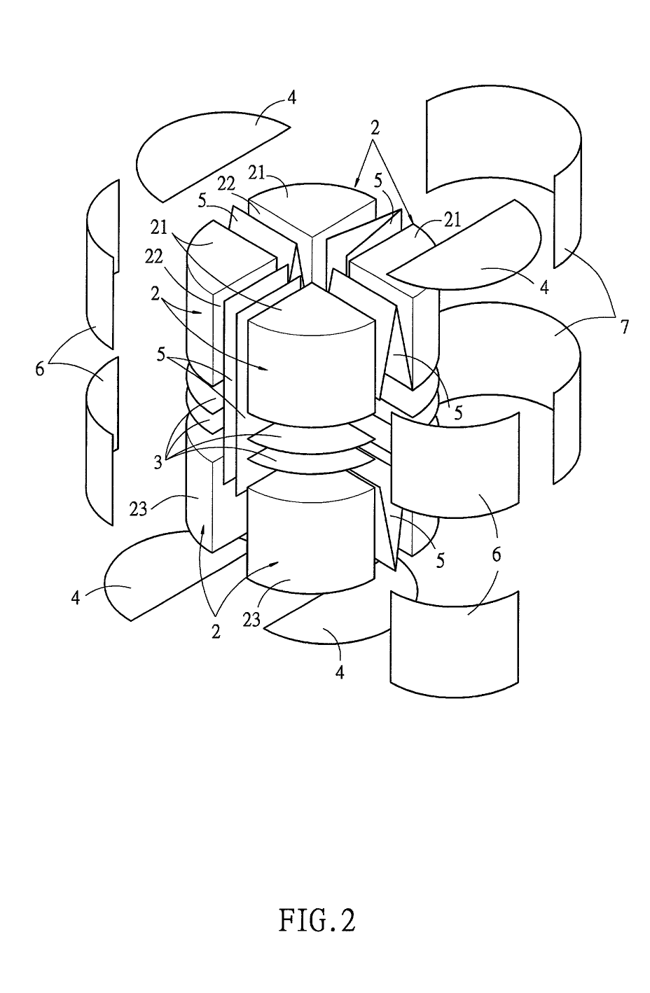

This invention is a cylinder (1) consisted by 8 fan-shaped columns (2). In FIG. 1 and FIG. 2., it is shown that there are 16 fan-shaped surface (21) pasted with 8 fan-shaped stickers (3) and 4 hemi-cycle stickers (4), 16 square surfaces (22) pasted with 8 double-block stickers (5), and 8 surfaces of circumference (23) pasted with 4 fan-shaped column stickers (6) and 2 hemi-cycle column stickers (7).

A sticker pasted on 2 surfaces may link the fan-shaped columns (2) together, which allows the columns to be turned, i.e. through the 4 hemi-cycle patterned stickers (4), 8 double-block stickers (5), and 2 hemi-cycle column stickers (7), each fan-shaped column (2) is linked together. Because the paper is foldable, this embodiment can be turned to present various and special look.

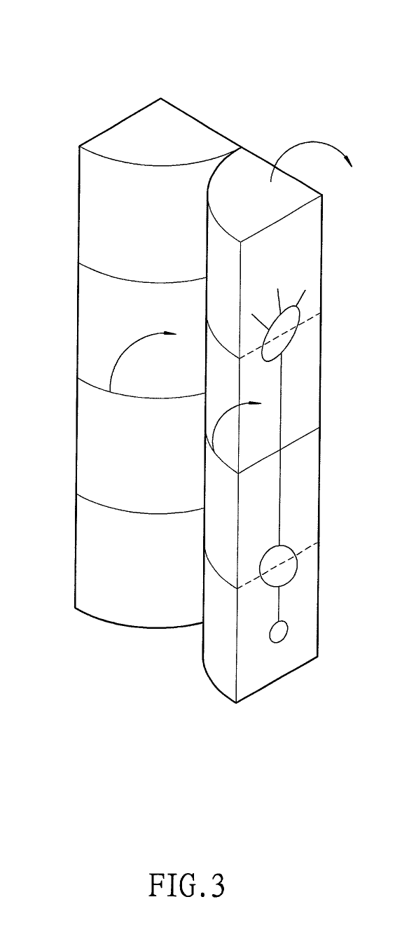

From the central part of the cylinder (1), take the fold line (11) of the 4 hemi-cycle stickers (4) on the upper and the subjacent cycle surfaces as the axis and turn, then take the fold line (11) of the double-block sticker (5) as the axis and turn, and then the invention may present a special look and several oblong advertisement patterns as shown in FIG. 3.

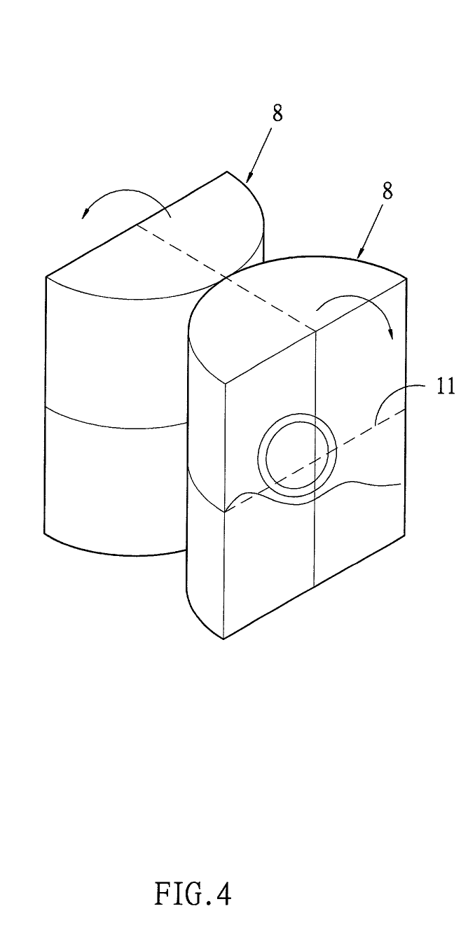

Next, follow the fold line (11) in the central part and turn, the invention becomes 2 semi-cycle columns (8) with backs against to each other as shown in FIG. 4. By doing this, the invention presents another 2 oblong advertisement patterns.

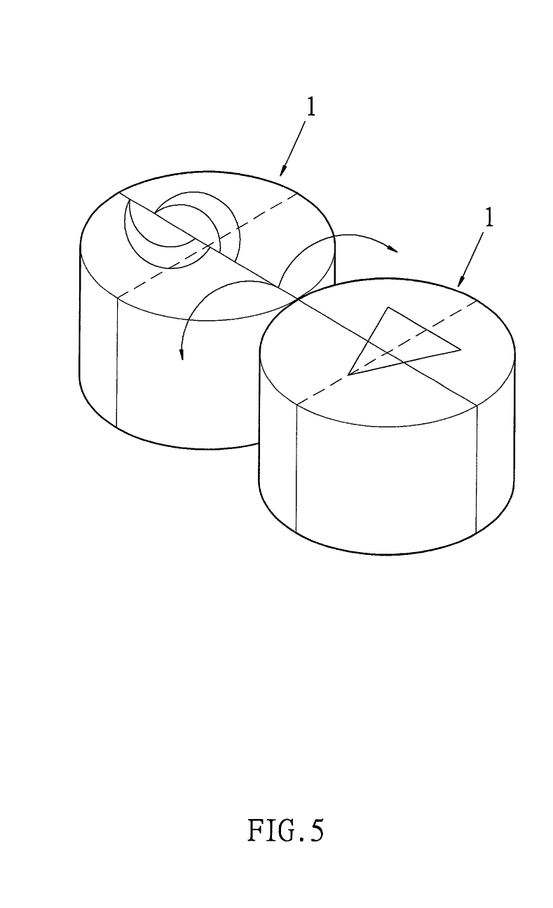

Take the fold line (11) as the axis and turn downward, and then this cylinder (1) then magically becomes 2 cylinders (1) and presents another 2 complete circle advertisement patterns as shown in FIG. 5. If follow the fold line and turn it outward, another special look may be presented. It can then be easily turned back to the original cylinder (1).

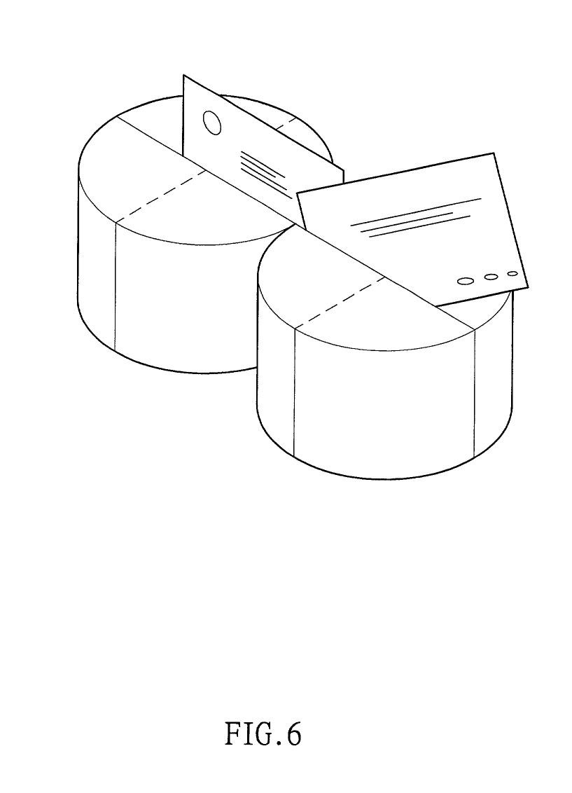

FIG. 6 is another example of this invention used as a card clip or note clip. It is full of so much creativity and fun and its multifunction also increases its practical value.

This invention of magic can is full of fun and variety, and can be changed into more special looks than ever. The stickers on each surface can also reach the visual and promotion effect. Besides, this invention can also be used as a card clip or other stationery. With so many functions, this invention has met the requirement of patent, and we therefore apply for the patent in accordance with the law. Your careful audition and approval of this application of patent will be much appreciated.

What is claimed is:

1. A magic can consisted of 8 fan-shaped columns forms 6 fan-shaped surfaces pasted with 8 fan-shaped stickers and 4 hemi-cycle patterned stickers, 16 square surfaces pasted with 8 double-block stickers, 8 surfaces of circumference pasted with 4 fan-shaped column stickers and 2 hemi-cycle column stickers. A sticker pasted on 2 surfaces may link the fan-shaped columns together. Through this way, these 8 fan-shaped columns may be turned so the invention may present other styles. Besides, this invention can also serve as a card clip or other stationery.
